(19) United States
(12) Patent Application Publication
(10) Pub. No.: US 2026/0318677 A1
(43) Pub. Date: Oct. 15, 2026

(54) Apparatus and Method of Vibration Compensation in an Interferometer

(71) Applicant: Bruker Nano, Inc., Santa Barbara, CA (US)

(72) Inventor: Haiming Wang, Fremont, CA (US)

(21) Appl. No.: 19/633,517

(22) Filed: Mar. 30, 2026

Related U.S. Application Data
(60) Provisional application No. 63/782,908, filed on Apr. 3, 2025.

(51) Int. Cl. G01B 11/24

(52) U.S. Cl. CPC G01B 11/2441

(57) ABSTRACT

An apparatus and method of white light interferometry includes compensating for system vibration when operating a scanning interferometer includes using the interferometer (such as a white light interferometer (WLI)) to collect interferometric data of a sample mounted on a stage. The method detects, substantially simultaneously with the using step, system vibration and generates a vibration signal. The method compensates the interferometric data using the detected system vibration. Distance measurement and in-line optical schemes may be employed to detect vibration.

### CROSS-REFERENCE TO RELATED APPLICATION

This application is a Non-provisional application claiming priority to Provisional application, U.S. Pat. App. No. 63/782,908, filed Apr. 3, 2025, the entirety of which is expressly incorporated by reference herein.

### BACKGROUND OF THE INVENTION

### Field of the Invention

The preferred embodiments are directed to 3D optical profilometry including white light interferometry (WLI) metrology, and more particularly, reducing the degradation of measurement results due to vibrations in the WLI system.

### Description of Related Art

The majority of non-contact areal profiler techniques are magnification dependent, which has led to the common use of high-resolution objectives with short working distances to achieve the best vertical resolution. White light interferometry (WLI), on the other hand, utilizes interferometric objectives that reveal the sample surface via a moiré pattern only when focus is reached. Due to the limited coherence length of white illumination, the depth of field for the moiré pattern does not exceed+1 micron, and the focal plane can be easily worked out within a couple of nanometers. Thus, the technique is independent from the objective, which guarantees nanometer precision even with low-magnification objectives (e.g., 1×, 2.5× or 5×). This provides significant metrology advantages.

Long working distance objectives can be used without compromising vertical resolution to access recessed or specific sample features. Ease of use is increased with the extra safety margin between the objective and the surface, with the ability to target challenging locations. A mirror can be inserted along the focusing beam to deflect the optical path to measure vertical walls with a high degree of precise locations in complex parts. If a large area needs to be measured, a single acquisition at low magnification can cover a wide area (100 mm²), making rapid detection of defects possible, as well as permitting high-throughput flatness control.

One major issue with interferometric measurements is the impact of system vibrations on measurement results. Attempts at overcoming this known problem have achieved less than ideal results. For instance, in U.S. Pat. No. 7,321,430, Vibration Resistant Interferometry, a line sensor and an external sensor for correcting vibration induced errors are provided. In the disclosed system, frame rate limits the frequency range of detectable vibrations; in other words, high frequency vibrations cannot be measured. In addition, the bi-refringent wedge causes lateral sharing interference on the array detector, whereby the detected interferogram is different from the interferogram detected by the array detector. This is often unsuitable for matching both interferograms, resulting in compensation complexity, yielding less than ideal results. More particularly, the sharing interferogram from reference path overlaps with the sharing interferogram from the 2nd array detector for signal path. As a result, the compensation of vibration induced errors may be inaccurate. As understood in the art, matching the outputs of two array detectors is challenging and susceptible to calibration errors.

In U.S. Pat. No. 7,855,791, Vibration-resistant Interferometric Scanning System and Method Thereof, a Mirau reference mirror blocks the high-coherent beam from propagating along the optical axis and falling on the Mirau reference mirror. Similar to the '430 patent, frame rate limits the frequency range of detectable vibrations. Also, in practice, it is likely that the wavelength of the narrow band high-coherent light is within the spectral bandwidth of the broadband low-coherent light. As a result, the two filters cannot completely separate these two light beams. In addition to the low-coherent light which interferes, the high-coherent light will also be detected. The high-coherent light will not interfere with the low-coherent light because it comes from a different light source, but it will form background intensity, degrading the interferogram contrast, adding noise, reducing measurement performance. Also, matching two array detectors, as described, is challenging and susceptive to calibration errors.

Other solutions have been tried, including algorithmic methods. Such methods have similar drawbacks in that they can only measure and compensate for vibrations in the direction perpendicular to the sample, or linear vibrations. When the sample has angular vibrations, meaning when the sample suffers time-dependent tilts, known attempts at accommodating system vibrations cannot measure and compensate for tilt.

In sum, the microscopy field was in need of an improved instrument capable of fast, high sensitivity interferometry. More particularly, WLI for 3D imaging that compensates for all system vibration, including angular vibration.

### SUMMARY OF THE INVENTION

The preferred embodiments are directed to high performance WLI. More particularly, the invention is directed to a white light interferometer that accommodates system vibrations, including compensating for multi-directional vibrations/tilt. The preferred embodiments do so by adding a vibration detection scheme that can be either in-line with appropriate optical processing, or using a distance measurement scheme, such as a DMI. The preferred embodiments are capable of high-speed vibration measurements to extend vibration detection and compensation to high frequency range, in a cost-effective way. In sum, the preferred embodiments enable improved performance separating the surface profile signal from vibration signals, and while providing ease of commercialization.

In one preferred embodiment, a method of compensating for system vibration when operating a scanning interferometer includes using the interferometer (such as a white light interferometer (WLI)) to collect interferometric data of a sample mounted on a stage. The method detects, substantially simultaneously with the using step, system vibration and generates a vibration signal. The method then compensates the interferometric data using the detected system vibration.

In another aspect of this embodiment, the detecting step includes measuring the distance between the optical head and the stage supporting a sample during the collecting step. Typically, the stage includes a reflective surface and the optical head is coupled to a distance measuring device such as a DMI.

According to a further aspect of this embodiment, the measuring step is performed at a plurality of locations on the stage, and the compensating step modifies the interferometric data due to system vibration in both vertical and angular directions. The sample may be a semiconductor wafer and the plurality of locations are spaced equidistant about the wafer.

In a still further aspect of this embodiment, the detecting step is performed using in-line detection without the need for a distance detecting device such as a DMI. The in-line detection includes using at least one single-point photodetector.

In a further aspect of this embodiment, the in-line detection circuit includes using a lock-in amplifier. Moreover, a plurality of single-point photodetectors may be employed to facilitate rapid high frequency vibration detection.

According to a still further aspect of this embodiment, the collecting step is performed using a white light interferometer (WLI) that performs phase shifting interferometry (PSI) using the single wavelength green LED.

In another embodiment, a white light interferometer (WLI) for generating an interferogram of a sample includes a) an illumination block including at least one light source generating a light beam, and b) an optical head including a beam splitter and a detector that measures interfering light beams to generate an interference signal. A compensation block is also provided and includes a means for detecting vibration. A system processor compensates the interference signal with the detected vibration.

According to another aspect of this embodiment, the means for detecting vibration measures the distance between the optical head and the stage supporting a sample during operation of the WLI.

In a further aspect of this embodiment, the means for detecting vibration as an in-line detection scheme includes at least one single-point detector. In addition, the in-line detection scheme may include a lock-in amplifier.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present 10 invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a block diagram of a white light interferometry (WLI) system of one preferred embodiment, allowing accommodation of vertical and angular vibration compensation;

FIG. 1A is a block diagram of a top plan view of a sample under test such as a semiconductor wafer, with several measurement devices operating according to the preferred embodiments;

Fi FIG. 2 is a block diagram of a white light interferometry (WLI) system of alternate preferred embodiment;

FIG. 3 is a block diagram of a white light interferometry (WLI) system of another alternate preferred embodiment;

FIG. 4 is a block diagram of a white light interferometry (WLI) system of a further preferred embodiment;

FIG. 5 is a graph illustrating a projection of the polarization of FIG. 4; and

FIG. 6 is a flow chart illustrating a method of compensating for vibrations when performing metrology, in particular, white light interferometry.

### DETAILED DESCRIPTION OF THE PREFERRED EMBODIMENTS

The preferred embodiments described herein improve white light interferometry (WLI) metrology performance, more specifically, reduce the impact of vibrations on measurement results. Each embodiment works to compensate for the effects of system vibrations on the detected interference signals. Most noteworthy is its capability of measuring not only linear vibrations in the direction of optical axis (the vertical vibrations), but also the angular vibrations corresponding to time-dependent tilt angle variations. In addition, the preferred embodiments are capable of high-speed vibration measurements to extend vibration detection and compensation to high frequency range, with an elegant and cost-effective solution. The preferred embodiments enable improved performance separating the surface profile signal from vibration signals, and while providing ease of commercialization.

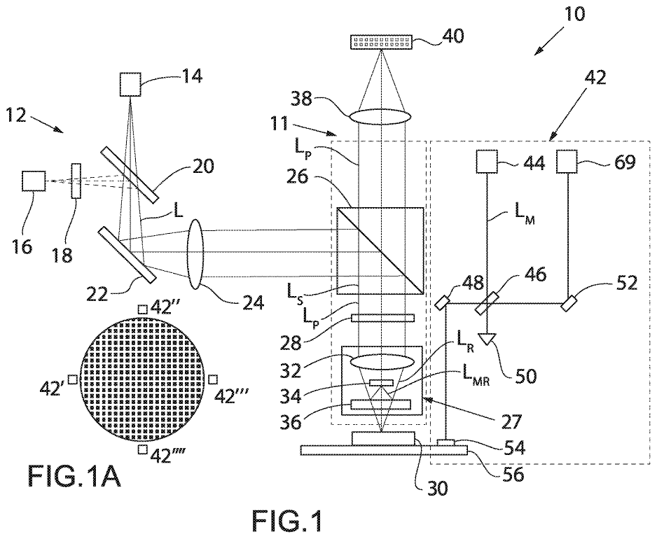

Turning initially to FIG. 1, an interferometer 10 for performing metrology, specifically white light interferometry (WLI), is configured to measure and account for both vertical and angular vibrations that may contaminate the acquired interferometric data. The system includes an optical head 11 (including the interference components) and an illumination module 12. Illumination module 12 may employ both a white LED 14 and a green LED 16, either or both of which direct energy toward a band pass filter (BPF) 18 that, together with a beam splitter 20 and a mirror 22, direct an illumination beam toward an objective 24. These components collectively make up the illumination module 12. This flexible illumination scheme enables powerful capabilities and functionalities, including but not limited to, the ability to perform phase shifting interferometry (PSI) using the single wavelength green LED 16, and vertical scanning interferometry (VSI) using the white LED 14.

PSI with single wavelength illumination, such as green LED 16, is capable of measuring a sample surface profile characteristics having a relatively shallow depth, e.g., measuring surface roughness with sub-nanometer resolution. Without phase unwrapping algorithms, the range of height in the surface profile in PSI is limited to half-wavelength of the illumination, which is usually less than a quarter of a micrometer. Though this limit can be extended with phase unwrapping algorithms, there are substantial disadvantages in using phase unwrapping, such as noise induced fake phase wraps, aliasing, ambiguity in distinguishing singular points caused by noise in the signal from surface discontinuities (phase jumps, for instance).

VSI employing a white LED is the basic operation mode for white light interferometry, which is capable of measuring substantially deep surface profiles, up to or exceeding, for instance, a few tens of micrometers in deep structures. This is particularly powerful in semiconductor back-end fabrication metrology, such as critical dimension (CD) and height of back-end structures such as after development inspection (ADI), after etch inspection (AEO), redistribution layer (RDL), and under-bump metallurgy (UBM) measurements. The preferred embodiments focus on vibration compensation for WLI measurements, but each has broader applicability in the interferometry field.

Selection of green LED 16 or white LED 14 is realized using a Filter Flip Motor (not shown) for illumination. The illumination energy or light is directed to the components of an optical head 11, including a polarizing beamsplitter (PBS) 26. Upon exit from PBS 26, s-polarized light Ls is reflected to a quarter waveplate 28 and focused onto a sample 30 being measured by an objective 32 of Mirau microscope 27.

The light beam LR reflected from the sample passes through a beam splitter 36 and interferes with the light beam LMR reflected from the Mirau reference mirror 34 in conventional interferometry fashion. Both light beams pass through quarter waveplate 28 again, become p-polarized, pass the PBS 26, and the beams Lp are directed to a measurement device 40 (e.g., a CMOS camera) via a tube lens 38.

To compensate for system vibrations, system 10 includes a compensation block 42 that measures system vibration and modifies the interferometer data (e.g., interferogram) using the measured system vibration. In this embodiment, compensation block 42 includes a distance measuring device or circuit, such as a distance measuring interferometer (DMI), to determine the distance between optical head 11 and a stage 56 holding sample 30. A laser beam from a laser 44 is directed toward a reflective element such as a mirror 54 mounted on sample holder or stage 56 that controls the position of sample 30 in the vertical or Z direction. When system vibrations (system operation, environment, etc.) cause stage 56 to move, the distance measured by DMI 42 varies as a function of time and provides a measurement of the sample vibration induced errors, which are used for compensating the interference signal collected by the CMOS camera.

More particularly, the laser beam LM is directed to a beamsplitter (BS) 46 sending part of the light to a heterodyne reference corner cube reflector 50 and part of the light to a mirror 48 that directs the light to sample mirror 54 mounted on stage 56. The sample mirror reflects light back toward DMI mirror 48 and is then transmitted by beam splitter 46, along with light reflect from corner cube 50 toward a second DMI mirror 52. Both light beams are combined by mirror 52, and directed towards a single-point photodetector 69. There is a polarizer with 45° azimuth angle upstream of single-point detector 48 to project the reflected beams to the same polarization direction, enabling their interference. The DMI 42 is able to measure the travel distances of the Z-stage/sample 56 accurately for accommodating system vibrations and thereby improve WLI measurement accuracy.

Two methods may be employed for vibration compensation, each using the measured stage distance signal(s). One, performing the compensation in hardware. For example, at a selected time t, the system identifies that the vertical scan is instructed to move a nominal distance h(t). At the same time, DMI 42 determines, according to the above WLI measurement, that the stage moved a distance d(t) due to system vibrations. With the known DMI data d(t), the actual vertical scan distance is compensated by the DMI data d(t), i.e., h(t)′=h(t)−d(t). Second, compensation may be implemented in software. Again, at a selected time t, the vertical scan needs to move k steps, corresponding to a phase aₖ. Also at time t, DMI 42 measures the stage moved a distance d(t) due to vibration(s). In calculating the VSI signal, instead of using the nominal phase, the system uses the vibration corrected phase aₖ−d(t).

Because the response time of the single-point photodetector 48 is much faster than the frame rate of CMOS camera 40, this embodiment is advantageous in that it is capable of measuring and compensating vibrations with a much broader frequency range in comparison with the methods disclosed in known systems.

To enable angular vibration detection and compensation, a plurality of the vibration detection devices is placed at strategically important locations, such as that shown in FIG. 1A. In this case, four (4) DMIs 42′, 42″, 42′″, 42″″ are placed at locations around a wafer, equidistant from one another, or four (4) locations around the perimeter of a sample under test. By collecting data from multiple locations, calculations are performed as follows, as an example. First, consider direction 42′-42′″ as x-direction, and 42″-42″″as y-direction.

The distance between 42′-42′″, dₓ, and the distance between 42″-42″″, d_{y}, are known from the placement of these devices. Suppose these four (4) devices measure distances [δ′(t), δ″(t), δ′″(t), δ″″(t)] at time t, then the angular tilt caused by system vibration will be,

$${a}_{x} = arctan \frac{{δ}^{′ ( t )} - {δ}^{′′′} ( t )}{{d}_{x}} . \qquad Equation 1$$

$${a}_{y} = arctan \frac{{{δ}^{″}}^{( t )} - {δ}^{′′′′} ( t )}{{d}_{y}} . \qquad Equation 2$$

With this angular tilt data, the resultant interferogram can be compensated using the hardware or software correction methods similar to the above two methods described above, with some advanced features particularly useful for measuring semiconductor wafers. For a typical semiconductor wafer, a plurality of measurement sites is defined according to the process requirements. These sites are located at different locations. Considering one specific location at (xₖ, yₖ), at a given time t, when the wafer is tilted in both of two orthogonal directions, depending on the distance of this location from the wafer center, the vertical distance change dk (f)=dk (xₖ, yₖ; t) caused by vibrations can be calculated with the above two angles in Equations (1) and (2). With this distance now known, the vibration can be compensated using either the hardware or software methods as described above, again, for this specific location at (xₖ, yₖ). All other sites can be compensated in the same way. It is noted that using one or more DMIs 42 as the vibration measurement device(s) is just for exemplary purposes. The illustrated arrangement of sensing components does not limit the scope of the preferred embodiments; instead, any and all dynamic proximity and displacement measurement apparatus and means may be used in these embodiments, including but not limited to, inductive proximity sensors, magnetic proximity sensors, capacitive proximity sensors, ultrasonic proximity sensors, fiber-optic proximity sensors, confocal displacement sensors, optical triangulation displacement sensors, for instance.

Turning next to FIG. 2, an interferometer 100 designed to account for and correct system vibrations removes the DMI of FIG. 1, making use of a green LED for vibration detection and compensation. In this embodiment, the Filter Flip Motor is not needed and removed. This system configuration substantially simplifies the design and building of the system, reduces the cost, enabling the in-line vibration detection and compensation, yet still maintains most of the measurement capabilities as those in the current system configuration with the DMI as shown in FIG. 1. This embodiment is especially suitable for most semiconductor metrology applications, in which white LED is sufficient for generating a sample interferogram, while the green LED signal is unnecessary for gathering the relevant interferometric data.

Unlike system 10 of FIG. 1, interferometer 100 of FIG. 2 includes an optical head 101 and an in-line vibration detection and compensation system 102 with a bandpass filter (BPF) and band-stop filter (BSF), together with a single-point detector to enable vibration detection over a broad range of frequencies, and substantially complete separation of the vibration signal from the acquired signal interferogram of a sample 111. An illumination block 104 is similar to that of the interferometer of FIG. 1, preferably including white and green LEDs 106, 108, respectively, and a bandpass filter (BPF) 110 in line with green LED 108 (or NIR). Illumination block 104 also includes a beam splitter 112 and a mirror 114 that directs the white and green electromagnetic energy toward a focusing objective 116 before being transmitted to an interference block 103.

The pair of filters, BPF 110 and a beam splitter 118 incorporating a band stop filter (BSF) 120 (e.g., film stack coated on beam splitter 118) enable separation of the green LED single-wavelength phase-shifting vibration detection from the white LED surface profile signal. The BPF 110 upstream of green LED 108 allows the single-wavelength green light beam to share a common path with the broadband white LED light beam. Both beams, after collimated by lens 116 and passing a polarizing beam splitter (PBS) 122, λ/4 waveplate 124 and a Mirau microscope 126 including an objective 128, a reference mirror 130 and a beam splitter 131, illuminate sample 111. In operation, the white and green beams are reflected upwardly and remain in a common path until arriving at beamsplitter with BSF 118 down stream of PBS 122 and tuned to the wavelength of green LED 108. The BSF 120 applied to beam splitter 118 reflects the green light towards a single-point detector 134 via a collimating lens 132 for vibration detection. The spectral components of the white LED light are within the stop band of the BSF. The spectral band the light is not allowed to pass has a stop band centering at the green LED wavelength. BSF 120 prevents the green LED light from passing it, and reflects it towards lens 132 and single-point detector 134. However, because this light comes from a light source different from the green LED 108, it will not interfere with the light from the green LED. Rather, this white light forms a background, causing some contrast reduction to the green LED interference fringes. Though that may be undesirable, it only affects the vibration detection path. In contrast, there is no fringe contrast reduction in the signal path because the green light is completely reflected towards single-point detector 134, not the measurement detector 140 (e.g., CMOS camera). This is an advantage over known systems.

A further improvement of separation of the vibration detection from the interferometric signal is possible by using a near infrared (NIR) LED to replace green LED 108. As a consequence, the BPF 110 and the BSF 120 of beam splitter 118 are replaced by a pair of beam splitters with dichroic coatings (not shown), i.e., a pair of so-called “hot mirrors.” For instance, replacing green LED 108 with an NIR LED of center wavelength 940 nm, which has no overlap with the spectrum of white LED 106. Then the beam splitter 112 upstream of the NIR LED is replaced by the hot mirror, which reflects the NIR light toward mirror 114 and passes the visible light from white LED 106. On beam splitter 118 above PBS 122, a hot mirror coating is also applied, which reflects the NIR light to single-point detector 134 via focusing component 132, and passes the visible light to the detector or CMOS camera 140. In this way, there is a complete separation of the vibration detection signal from the surface profile interferometric signal.

In sum, the FIG. 2 embodiment enables expanded high frequency vibration detection and improved vibration separation from the signal interferogram data. The scheme for accommodating vibration in the system removes the DMI, making use of the green LED for vibration detection and compensation. The Filter Flip Motor is not needed in this embodiment, and therefore removed from the FIG. 1 embodiment. This system configuration simplifies the design and build of the system, reduces the cost, enabling in-line vibration detection and compensation, yet still maintains most of the measurement capabilities as those in the current system configuration with the DMI as shown. In this embodiment, the green LED is not used for measurement purposes; rather, it is either replaced with an NIR LED, or directly used for vibration compensation. This may be disadvantageous for some very specific applications which require using green LED for PSI measurements. On the other hand, this embodiment is especially suitable for most semiconductor metrology applications, in which white light interferometry is sufficient, and adding a green LED is unnecessary. The BPF-BSF pair of filters is the facilitator for separating the green LED single-wavelength phase-shifting vibrations detection from the white LED surface profile signal.

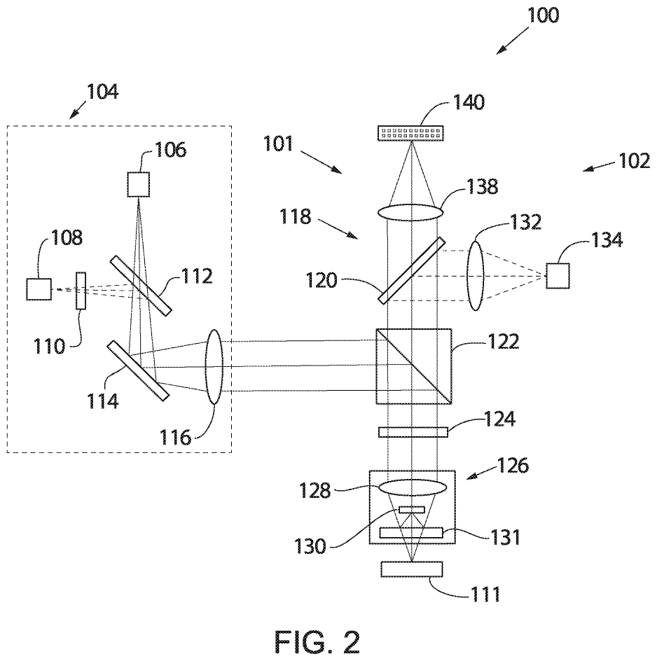

Another alternative is shown in FIG. 3. Interferometer 200 is similar to the FIG. 2 embodiment with the exception that the separation of vibration detection from interferometric signal is realized using frequency modulation (FM). It is an in-line vibration detection and compensation system employing an intensity modulator of one of the light sources at frequency f. A lock-in amplifier is provided to demodulate the high frequency, low noise vibration and complete separation of the vibration noise from the signal interferogram data.

Interferometer 200 includes an illumination module 202 having, once again, white and green LEDs, 204, 206, respectively. In the green LED 206 path, module 202 includes a bandpass filter 208 (the same BPF used in the standard WLI, with a very narrow spectral band (less than a few nm) centering at a single wavelength, about 500 nm), and an intensity modulation device 210 downstream of band pass filter (BPF) 208 that may include, but is not limited to, a mechanical chopper, acousto-optic modulator (AOM), electro-optic modulator (EOM), magneto-optical modulator (MOM), photoelastic modulator (PEM), for instance. These modulators may need a polarization means (not shown) for intensity modulation depending on the principle of intensity modulation. For instance, the crystal used in an AOM is sensitive to polarization. MOM and EOM are similarly sensitive to polarization. PEM is based on the stress-induced difference in refractive indices of two orthogonally polarized light beams—in principle it is a polarization effect. On the other hand, mechanical chopper does not need a polarization means.

After passing modulator 210, the green light is characterized with time-dependent intensity modulation at a specific frequency based on the requirements for the signal level and frequency separation. For instance, the white light LED, without modulation, has a very low frequency, substantially a DC beam. The higher modulation frequency of the green LED beam, the purer (frequency components near the lock-in frequency, reject other frequency components like noise-background contributions rejected) the signal being received by the lock-in amplifier, yet the lower the signal level. As a result, the selection of the modulation frequency is a practical choice optimized in the practical design architecture of the system. This frequency may be as high as, for instance, about 200 MHz, and in any case, substantially higher than the frame rate of CMOS camera 240. White light passes a beam splitter 212 and is transmitted to modulator 210. Similar to the 2nd embodiment, the green light and the white light beams are in common path until a beam splitter 230 down stream of a polarizing beam splitter (PBS) 218.

More particularly, and similar to the previous embodiment, both beams, after collimated by lens 216 and passing a polarizing beam splitter 218, λ/4 waveplate 220 and a Mirau microscope 222 including an objective 224, a reference mirror 226 and another beam splitter 227, illuminate sample 211. In operation, the white and green beams are reflected upwardly and remain in a common path until arriving at a beamsplitter 230 down stream of PBS 218. Beam splitter 230 reflects the green light towards a single-point detector 234 via a collimating lens 232 for vibration detection. Unlike the previous embodiment, beam splitter 230 does not include BSF, and instead employs a lock-in amplifier 236 that allows single-point photodetector 234 to detect the vibration signal, i.e., demodulate the high frequency, low noise vibration and complete separation of the vibration noise from the signal interferogram data. Similar to the previous embodiment, there is no fringe contrast reduction in the signal path because the green light is completely reflected towards single-point detector 234, not the measurement detector 240 (e.g., CMOS camera). Again, an advantage over known systems.

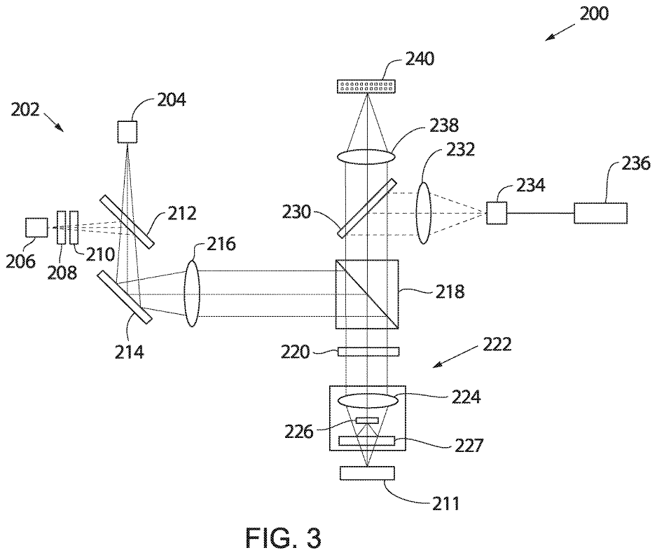

FIG. 4 illustrates in-line vibration detection and compensation with a plurality of multiple single-pointer detectors, or single-pointer detectors and image cameras. This embodiment can be realized based on either the embodiment of FIG. 2 with a pair of filters, BPF 110 and BSF 120, or the FIG. 3 embodiment having an intensity modulation device 210 with a lock-in amplifier 236 for vibration detection. FIG. 4 shows an implementation of this alternative based on the FIG. 2 embodiment, but it is not limited to this example only.

Starting with the system similar to that shown in FIG. 2, an interferometer 300 adds a polarizer 308 at 90° azimuth angle downstream of a white light LED 304 so the exiting light beam is s-polarized, while another polarizer 312 at 45° azimuth angle downstream of green LED 306 and a band pass filter 310 is provided so its exiting light beam is p-polarized. As a result, the system employs illumination having both s-polarization and p-polarization components. After exiting a beam splitter 314 and reflected by a mirror 316, the two beams are collimated using objective 318. Both beams then arrive at a polarizing beam splitter (PBS) 320, and the two beams become three (3) beams:
Beam A: The s-polarized white LED light beam.
Beam B: The s-polarized component of green LED light beam.
Beam C: The p-polarized component of the green LED light beam.

Both Beams A and B are reflected towards a quarter waveplate 328, passing through it, becoming circularly polarized, and are directed to an objective 332 of a Mirau microscope 330. Both beams A and B are then directed to the Mirau reference mirror 334 and a Mirau beam splitter 335 and onto a sample 311. Each beam is split into a sample beam reflected by sample 311 and a reference beam. As a result, there are four (4) beams after the reflection:
Beam AS: Sample beam from Beam 1, white light.
Beam AR: Reference beam from Beam 1, white light.
Beam BS: Sample beam from Beam 2, green light.
Beam BR: Reference beam from Beam 2, green light.

All four (4) beams pass through quarter waveplate 328 again, become p-polarized, and thus can pass through PBS 320, arrive at the beam splitter (BS) 336 with band stop filter (BSF) component 338. The white light beams, Beam AS & Beam AR, and not the green spectrum component, form the interferogram signal path, passing through the beam splitter 336, a focusing objective 340 and arrive at a CMOS camera 342. It is these beams that interfere to provide detectable data that can be assembled into an interferogram and from which the surface profile signal is measured and analyzed, e.g., in conventional white light interferometry.

Next, the reference path will be discussed. First, Beam C, after passing through quarter waveplate 322, becomes circularly polarized. It is collimated by an objective 324 and reflected by a second reference mirror 326, passing through quarter waveplate 322 again, becomes s-polarized, and is reflected by PBS 320 towards beam splitter 336 with BSF 338. As a result, in the reference path, there are the following beams with different polarization components:
Beam AS: Sample beam from Beam A, green component from the white light, p-polarized.
Beam AR: Reference beam from Beam A, green component from the white light, p-polarized.
Beam BS: Sample beam from Beam B, green light, p-polarized.
Beam BR: Reference beam from Beam B, green light, p-polarized.
Beam C: Reference beam reflected by the 2nd reference mirror 326, s-polarized.

All the above beams are reflected by the beam splitter with BSF towards a beam splitter 344, and then directed to the three single-point photodetectors (PDs), each having a function described as follows.

With respect to first single-point photodetector (PD1) 346, beam splitter 344 directs part of the beam toward a polarizer 343 set at zero degrees, i.e., p-polarization, and focusing objective 345. PD1 346 detects interferometric data for delivering two interferograms from four beams: a first interferogram generated from Beam AS interfering with Beam AR, and a second interferogram from Beam BS and Beam BR. Both interferograms consist of information about the phase difference the signals between Mirau reference mirror 334 and sample 311, but the interference of Beams AS with AR and Beams 2S with 2R overlap and cannot be separated. As a result, PD1 346 detects the averaged phase difference across the green spectrum component of the white light, Beams AS with AR, and the green light, Beams BS with BR, respectively. This phase difference information is detected and contains the vibration information when the stage or the sample vibrates, and therefore is used for vibration compensation purposes.

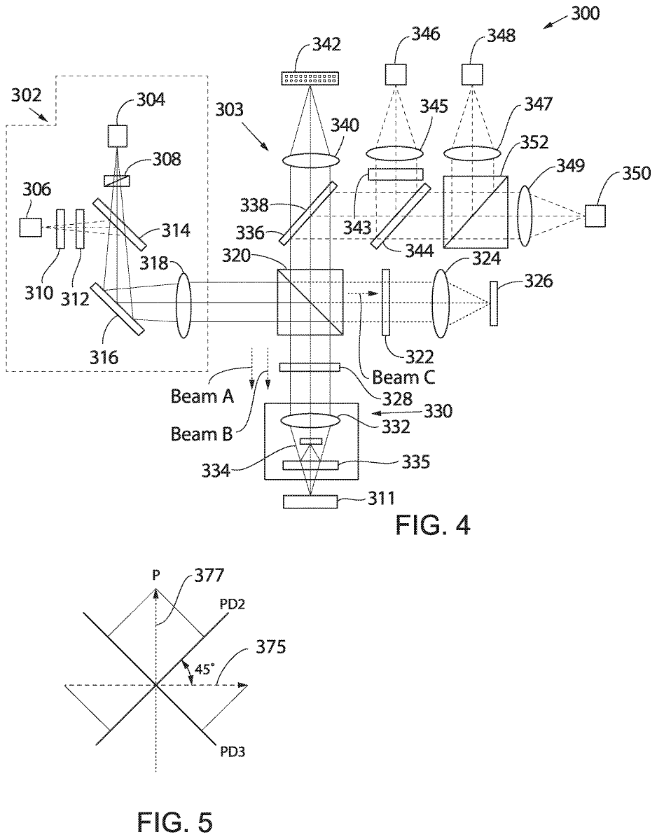

Next, single-point photodetectors 348 (PD2) and 350 (PD3) operate as follows. As shown in complementary FIG. 5, because a second polarizing beam splitter (PBS) 352 is positioned at 45° azimuth angle, both the s-polarized 375 and p-polarized 377 components from the above-described five beams are projected to the local s-polarization and p-polarization directions of PBS 352, as shown in FIG. 5. Detectors 348, 350 receive the polarized light via focusing objectives 347, 349, respectively.

More specifically, the detected interferometric signal values are characterized by,

$${E}_{P D 1} = {r}_{B S p} ( {E}_{A S} + {E}_{A R} + {E}_{B S} + {E}_{B R} ) {E}_{P D 2} = {t}_{B S p} ( {E}_{A S} + {E}_{A R} + {E}_{B S} + {E}_{B R} ) cos \frac{π}{4} + {t}_{B S s} {E}_{C} cos \frac{π}{4} {E}_{P D 3} = - {t}_{B S p} ( {E}_{A S} + {E}_{A R} + {E}_{B S} + {E}_{B R} ) cos \frac{π}{4} + {t}_{B S s} {E}_{C} cos \frac{π}{4} . \qquad Equation 3$$

Where r is the reflection coefficient, and t is the transmission coefficient, complex variables. The intensities detected by these three PDs are given by

$${I}_{P D 1} = {R}_{B S p} [ {I}_{A S} + {I}_{A R} + {I}_{B S} + {I}_{B R} + 2 ( \sqrt{{I}_{A S} {I}_{A R}} + \sqrt{{I}_{B S} {I}_{B R}} ) cos {ϕ}_{s m 1} ] . \qquad Equation 4$$

$${I}_{P D 2} = {cos}^{2} \frac{π}{4} \{ \begin{matrix}{T}_{B S p} [ {I}_{A S} + {I}_{A R} + {I}_{B S} + {I}_{B R} + 2 ( \sqrt{{I}_{A S} {I}_{A R}} + \\ \sqrt{{I}_{B S} {I}_{B R}} ) cos {ϕ}_{s m 1} ] + {T}_{B S s} {I}_{C} + 2 \sqrt{{T}_{B S p} {T}_{B S s} {I}_{C}} \\ ( \sqrt{{I}_{B S}} cos {ϕ}_{s m 2} + \sqrt{{I}_{B R}} cos {ϕ}_{m 1 m 2} )\end{matrix} \} . \qquad Equation 5$$

$${I}_{P D 3} = {cos}^{2} \frac{π}{4} \{ \begin{matrix}{T}_{B S p} [ {I}_{A S} + {I}_{A R} + {I}_{B S} + {I}_{B R} + 2 ( \sqrt{{I}_{A S} {I}_{A R}} + \\ \sqrt{{I}_{B S} {I}_{B R}} ) cos {ϕ}_{s m 1} ] + {T}_{B S s} {I}_{C} - 2 \sqrt{{T}_{B S p} {T}_{B S s} {I}_{C}} \\ ( \sqrt{{I}_{B S}} cos {ϕ}_{s m 2} + \sqrt{{I}_{B R}} cos {ϕ}_{m 1 m 2} )\end{matrix} \} . \qquad Equation 6$$

Equations (5) & (6) yield:

$${I}_{P D 2} + {I}_{P D 3} = {T}_{B S p} [ {I}_{A S} + {I}_{A R} + {I}_{B S} + {I}_{B R} + 2 ( \sqrt{{I}_{A S} {I}_{A R}} + \sqrt{{I}_{B S} {I}_{B R}} ) cos {ϕ}_{s m 1} ] + {T}_{B S s} {I}_{C} . \qquad Equation 7$$

$${I}_{P D 2} - {I}_{P D 3} = 2 \sqrt{{T}_{B S p} {T}_{B S s} {I}_{C}} ( \sqrt{{I}_{B S}} cos {ϕ}_{s m 2} + \sqrt{{I}_{B R}} cos {ϕ}_{m 1 m 2} ) . \qquad Equation 8$$

The spectral reflectance and transmittances of the beam splitter at the green light wavelength, R_{BSp}, T_{BSp}, and T_{BSs}, together with the intensities of these five beams, I_{AS}=|E_{AS}|², I_{AS} =|E_{AS}|², I_{AR}=|E_{AR}|², I_{BS}=|E_{BS}|², I_{BR}=|E_{BR}|², and I_{C}=|E_{C}|², can be calibrated. We can then use the relation,

$${ϕ}_{m 1 m 2} - {ϕ}_{sm 2} = {ϕ}_{sm 1} . \qquad Equation 9$$

to these phases from Equations (1), (7), and (8). We can then use the results for vibration detection and compensation purposes.

The benefit of this relatively more complex system is that it is real-time, and self-calibrated. With five Equations (4-8 above) and the constraint Equation (9), the system can solve three (3) phase terms:

φₛₘ₁: The phase difference between beams AS & AR, also the phase difference between beams BS & BR, because these beams have the same wavelength and propagate along the same paths. With the wavelength of green light known, the optical path difference of these beams is solved as,

$${OPD}_{sm 1} = \frac{λ {ϕ}_{sm 1}}{4 π} . \qquad Equation 10$$

This is the average OPD between the wafer (e.g., sample 311) and reference mirror 334 inside Mirau microscope 330, which is also the vibration induced distance movement of the wafer in the white light signal, and used for compensating the impact of vibrations on the measurements.

φₛₘ₂: The phase difference between beams BS & C. Again, with the wavelength of green light known, the optical path difference of these beams is solved as,

$${OPD}_{sm 2} = \frac{λ {ϕ}_{sm 2}}{4 π} . \qquad Equation 11$$

This signal contains the average distance movement of the wafer caused by vibrations, and the average distance movement of reference mirror 326, or optical path length changes in the reference path related to the reference mirror 326. Simply put, this signal is representative of vibrations, as well as other errors, in the reference path.

φₘ₁ₘ₂: The phase difference between beams BR & C. Again, with the wavelength of green light known, the optical path difference of these beams is solved as,

$${OPD}_{m 1 m 2} = \frac{λ {ϕ}_{m 1 m 2}}{4 π} . \qquad Equation 12$$

This signal does not contain the average distance movement of the wafer, but the average distance movement between the two reference mirrors, the one 334 inside Mirau microscope 330, and reference mirror 326. As a result, from the above three OPD signals, the system can not only compensate for the impact of vibrations, but also some other errors in the system.

Mathematically, determination of these three (3) OPD signals from the six (6) equations described immediately above is an overdetermined problem. One can either take advantage of overdetermination to improve the signal-to-noise ratio of the solution, or use the redundant equations to solve other parameters in the system.

Finally, converting the phase signals to the OPD signals is helpful for using φₛₘ₁ to compensate for the impact of vibrations on the white light measurements, because the white light signal covers the visible spectrum, while φₛₘ₁ is only determined by the single wavelength of the green LED. Thus, the phase signal cannot be directly used for the compensation, while the OPD signal, on the other hand, has the wavelength removed and is the same as in both white light and single wavelength.

Similar to embodiment in FIG. 2, complete separation of surface profile signal from vibration detection can be enabled by replacing the green LED with a LED with wavelength not overlapping with the spectral range of the white LED, for instance, using a near infrared (NIR) LED with center wavelength at 940 nm.

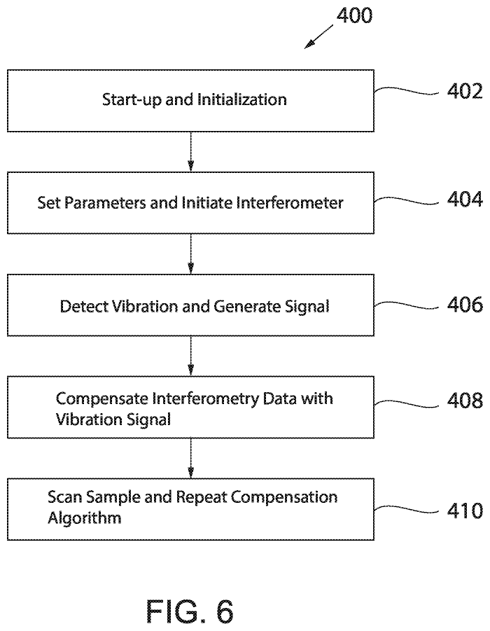

Turning to FIG. 6, a method 400 of white light interferometry according to the above embodiments are shown. After a start-up and initialization Block 402, method 400 collects interferometric data associated with a sample under test with the WLI in Block 404. Substantially simultaneously, in Block 406, system vibration is detected and a vibration signal is generated. The vibration signal is used in Block 408 to compensate for the effects of the vibration on the interferometric data. In Block 410, the algorithm is repeated for the entire scanned sample. The corrected/compensated interferometer data can be generated in real-time or after scanning the sample and generating, for example, an interferogram. The techniques for collecting the vibration information and compensating the interferometric data are as described above with respect to the different embodiments.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. A method of compensating for system vibration when operating a scanning interferometer, the method comprising:
using the interferometer to collect interferometric data of a sample mounted on a stage;
detecting, substantially simultaneously with the using step, system vibration and generating a vibration signal; and
compensating the interferometric data using the detected system vibration.

2. The method of claim 1, wherein the detecting step includes measuring the distance between an optical head and the stage supporting the sample during the collecting step.

3. The method of claim 2, wherein the measuring step is performed at a plurality of locations on the stage, and the compensating step modifies the interferometric data due to system vibration in both vertical and angular directions.

4. The method of claim 3, wherein the sample is a semiconductor wafer and the plurality of locations are spaced equidistant about the wafer.

5. The method of claim 2, wherein the measuring step is performed using a distance measuring interferometer (DMI) and a reflecting element coupled to the stage.

6. The method of claim 5, wherein the DMI is coupled to the optical head.

7. The method of claim 1, wherein the detecting step is performed using in-line detection.

8. The method of claim 7, wherein the in-line detection includes using at least one single-point photodetector.

9. The method of claim 8, wherein the in-line detection includes using a lock-in amplifier.

10. The method of claim 8, wherein the in-line detection includes using a plurality of single-point photodetectors.

11. The method of claim 1, wherein the collecting step is performed using a white light interferometer (WLI) employing phase shifting interferometry (PSI) using a single wavelength green LED.

12. A white light interferometer (WLI) for generating an interferogram of a sample, the WLI comprising:
an illumination block including at least one light source generating a light beam;
an optical head including a beam splitter and a detector that measures interfering light beams to generate an interference signal;
a compensation block including a means for detecting vibration; and
a processor that compensates the interference signal with the detected vibration.

13. The WLI of claim 12, wherein the means for detecting vibration is to measure the distance between the optical head and the stage supporting the sample during operation of the WLI.

14. The WLI of claim 12, wherein the means for detecting vibration as an in-line detection scheme includes at least one single-point detector.

15. The WLI of claim 14, wherein the in-line detection scheme includes a lock-in amplifier.
